(19) United States
(12) Patent Application Publication
(10) Pub. No.: US 2009/0280706 A1
(43) Pub. Date: Nov. 12, 2009

(54) Method for Providing a Flame Retardant Finish of a Textile Article

(76) Inventors: Johannes Antonius Craamer, Ijlst (NL); James E. Fox, Cambridge (GB); Jagvi Ramesh Patel, Cambridgeshire (GB)

Correspondence Address: HOWREY LLP-EU, C/O IP DOCKETING DEPARTMENT, 2941 FAIRVIEW PARK DR., SUITE 200, FALLS CHURCH, VA, 22042, US

(21) Appl. No.: 11/886,861

(22) PCT Filed: Mar. 22, 2006
(86) PCT No.: PCT/EP2006/060972

§ 371 Date: Sep. 21, 2007

(30) Foreign Application Priority Data
Mar. 22, 2005 (GB) 0505892.0

(51) Int. Cl. B32B 5/02; B05D 1/02; B05D 1/04; C09K 21/04

(52) U.S. Cl. 442/142; 427/424; 427/458; 442/141; 252/608

(57) ABSTRACT

A method of producing a textile article having a flame retardant finish comprising: providing a continuous supply of a textile substrate having a width; providing an array of digital nozzles over the width of the textile article; supplying a flame retardant formulation to the nozzles; and selectively dispensing the flame retardant formulation from the nozzles in a series of droplets to deposit a predetermined pattern of droplets on the substrate.

### BACKGROUND OF THE INVENTION

1. Field of the Invention

The present invention relates to a process for upgrading a textile article. In particular, the invention relates to a digital procedure for producing a flame retardant textile article and to the flame retardant textile article resulting therefrom.

2. Description of the Related Art

The production of textiles traditionally takes place in a number of distinct processes. Typically five stages can be distinguished in such production; the fibre production; spinning of the fibres; the manufacture of cloth (for instance woven or knitted fabrics, tufted material or felt and non-woven materials); the upgrading of the cloth; and the production or manufacture of end products. Textile upgrading covers a number of operations such as preparing, bleaching, optically whitening, colouring (dyeing and/or printing) and finishing. These operations generally have the purpose of giving the textile the appearance and physical and functional characteristics that are desired by the user.

During dyeing, the textile substrate is usually provided with a single full plane colour. Dying presently takes place by immersing the textile article in a dye bath, whereby the textile is saturated with an appropriate coloured chemical substance. During both dyeing and printing the primary goal is to change the colour of the substrate. This is thus an aesthetic effect, characterized by the use of permanent inks or pigments, which have absorption properties between 400 and 700 nm.

The primary goal of finishing is to use auxiliary chemicals to change the physical and/or mechanical characteristics of the textile. These finishing techniques are meant to improve the properties of and/or add properties to the final product. A distinction will henceforth be made between colouring and finishing. Where necessary, finishing may be understood to exclude treatments involving the deposition of particles that are applied to the substrate only because of their absorption properties between 400 and 700 nm.

Coating of the textile is one of the more important techniques of finishing and may be used to impart various specific characteristics to the resulting product It may be used for making the substrate fireproof or flameproof water-repellent, oil repellent, non-creasing, shrink-proof, rot-proof, non-sliding, fold-retaining, antistatic and the like. Coating of textile involves the application of a thin layer of an appropriate chemical substance to the surface of the textile substrate. The coating may serve to protect the textile substrate or other underlying layers. It may also be used as a basis or “primer” for subsequent layers or may be used to achieve desired special effects.

The usual techniques for applying a coating on solvent or water basis are the so-called “knife-over-roller”, the “dip” and the “reverse roller” screen coaters. A solution, suspension or dispersion of a polymer substance in water is usually applied to the cloth and excess coating is then scraped off. For such procedures to be effective, the coating formulation must be in a highly viscous, pasty form. For many functionalities it is not possible to bring the formulation into such a viscous state without adversely affecting the functionality. This may be due to the fact that thickening agents are incompatible with the functional chemical.

A further procedure sometimes employed for finishing of the textile is the use of immersion or bath techniques such as foularding. The textile is fully immersed in an aqueous solution containing the functional composition that is to be applied. Subsequent repeated cycles of drying, fixation and condensation are required to complete the operation. This leads to considerable use of resources, in particular water and energy. In general, the solutions, suspensions or dispersions used for such techniques have low concentrations of the desired functional composition.

It has been suggested in unexamined patent application No. JP61-152874 to Toray Industries, to impregnate a textile sheet with a functional composition in the form of dots. Various functional compositions are suggested including antibiotics, moisture absorbents, water repellents, antistatic agents, ultraviolet rays absorbents, infrared rays absorbents, optical whitening agents, swelling agents, solvents, saponifier, embrittlement agent, inorganic granules, metal granules, magnetic material, flame retardants, resistance, oxidants, reducing agents, perfumes, etc. The document indicates that traditional photogravure roll and screen print methods produce patterns of dots that may be too large, while in spraying techniques, the dot size and quantity of product deposited is difficult to control. The document proposes impregnating a textile with a functional composition in the form of dots, wherein a mean dot diameter is 30 to 500microns and the occupied area ratio thereof is 3 to 95%. Although the document suggests the use of inkjet printing techniques, it identifies conventional inkjet devices as being unsuitable, in particular due to the high viscosity of traditional coating compositions. The document is concerned primarily with maintaining an identifiable droplet structure and preventing the droplets from running together. Furthermore, the document provides examples regarding the use of solutions but fails to address the problems of inkjet deposition of dispersions or suspensions.

Inket printers of various types are generally known for providing graphic images. Such printers may be desktop inkjet printers such as used in the office or home and are generally used for printing onto a particular type of paper substrate (printer paper), using small droplets (<20 pL) of water based inks containing colorants. Larger, industrial inkjet printers also exist for printing graphic images or date/batch codes onto products; these printers are typically printing onto non-porous substrates using solvent based inks containing colorants pigments. Such formulations are not however suitable for application to most textiles in particular due to lack of colour fastness. In order to print onto textiles using inkjet techniques, textile articles have in the past been pretreated with a coating onto which ink droplets may be applied. For upgrading purposes, most currently used coatings and finishing compositions are unsuitable for deposition using inkjet techniques. Industrial inkjet printers and nozzles that produce large droplets are generally designed for use with solvent based, coloured inks. Furthermore, the droplet volumes that can be jetted are extremely low, in the order of 50 pL and mostly insufficient for textile finishing, where a significant penetration into the fabric is necessary. Typical finishing formulations are mostly water based and generally have particle sizes that can cause clogging of the nozzles. Additional problems with foaming, spattering and encrustation have been encountered. When working with large numbers of nozzles operating continuously at up to 100 KHz, reliability and fault free operation are of prime importance. While indicating that conventional inkjet devices are unsuitable for applying finishing compositions, JP61-152874 fails to provide teaching regarding how this could be improved.

A number of finishing techniques require a substantially continuous and complete coverage in order to achieve their effect One functionality that requires complete coverage is flame retardency. Here, it is important to ensure that the textile item is completely protected while avoiding excessive deposition of a fire retardant formulation onto the textile substrate that could be detrimental to other qualities of the textile such as comfort and touch. Many commercial textile products are required by law to have smoke suppressant and flame retardant properties in order to prevent the spread of these hazards through the textile material in the event of a localized fire. However, many of the fibres typically used in the production of such products do not in themselves suppress smoke or flames: the choice of fibrous material is often made on the basis of the softness, durability or pliability of the fibres before consideration of their response to intense heat. For example, polylactic acid (PLA) fibres are known to provide a soft, subtle surface to textiles containing them but have been shown to ignite easily. Conversely, it is known that certain fibers, and in particular nylon fibers, do not support flames or combustion well; however these fibres can melt and this allows for any supplementary materials in the textile, such as polyvinylchloirde commonly included as a textile support layer, to ignite.

The need to modify the performance of fibres during their normal period of use has led to the development of a number of durable fire retardants which are applied to fabrics in the finishing of the textile. Typically these include chemical formulations that are intended to bind or coat the fibers without loss of the textiles' functionality. Alternatively, the fire retardant may comprise one of two types of intumescent particles which are distributed throughout that layer of the textile that is most likely to be exposed to a heat or fire source. On such exposure, a first type of these particles melt, fuse and char forming an inert coating layer which protects inner layers of the textile. Alternatively, intumescent particles may be designed to encapsulate an inert gas that expands when heated and then escapes from the particle into the textile thereby yielding flame retardance.

As indicated above, conventional techniques used to apply liquid flame retardants typically comprise impregnating or saturating the textile article with the relevant compounds. United States Patent Application No. 2002/115750 (Ghassan) describes a process in which textile fibres are saturated with an equimolar aqueous solution of monoammonium phosphate, diammonium phosphate and a metal hydroxide. The saturated articles are then dried and mixed with a modified glue, formed into a mat and then placed under high pressure. The use of this saturation technique is restrictive in that it necessarily applies to the whole article: for example, the compounds cannot selectively saturate the outermost surface of the article. Imparting other functional properties to a whole or part of the article may therefore necessitate the addition of further materials or layers into the textile to complement the flame retardant portion thereof. Additionally, the described process comprises a number of disparate steps such that it cannot be performed continuously. Furthermore, the ubiquity of the process has to be put in question as it is easy to conceive of articles to which the glue may not be applied easily or evenly.

WO2004/053223 (Dow Global Technologies Inc.) describes an alternative to impregnation that comprises frothing an aqueous polyurethane formation, applying the froth to the textile substrate and drying the froth into a high density foam therein. The step of drying will change the nature and extent of aeration (or vacuolation) of the polyurethane but it is difficult to envisage that this can occur evenly within the fibers. As such it may generate variation in the flame retardancy in the finished article.

WO2003/044266 describes a method of coating, spraying or sprinkling intumescent particles into the upper surface of an article, wherein the particles act by forming a charred layer on exposure to excess heat. The operation of this effect relies on the provision of a continuous char layer: theoretically this could be achieved by either precise emplacement of the intumescent particles or-by saturating the material with the particles. The method of this prior art document utilises the saturation methodology and it necessarily follows that the quantity of chemicals it employs must impact on the structural properties of the textile, and in particular its weight and flexibility. Reducing the quantity of applied chemicals would lead to undesirable regions of uncoated substrate, since the spraying procedures used are inherently somewhat inaccurate.

There is consequently a need in the art to provide a method for finishing a textile article wherein a flame retardant or smoke suppressant formulation can be included therein with precise coverage and to a specific depth of penetration into the articles. There is also a need in the art to provide a method for precise emplacement of intumescent particles to enable the formation of a continuous char layer on exposure of the textile to a heat source or flame but without the need to use excessive amounts of formulation or a saturation methodology. There is also a need for a formulation that can successfully and accurately be applied using inkjet deposition technology and which does not leave flammable residues on the textile upon drying.

### BRIEF SUMMARY OF THE INVENTION

According to the present invention there is provided a method of producing a textile article having a flame retardant finish comprising: providing a continuous supply of a textile substrate having a width; providing a first array of digital nozzles over the width of the textile article; supplying a flame retardant formulation to the nozzles; and selectively dispensing the flame retardant formulation from the nozzles in a predetermined pattern of droplets to produce a substantially complete covering of the substrate with no significant flammable residue.

The term ‘textile’ is used herein for any substrate in general, or more specifically any fabric, and then in particular clothing flags, tent-cloths and the like on which the operations of painting, coating and / or finishing (and printing) can be performed. The term is not intended to include paper and cardboard. These fibrous articles, although sometimes referred to as textiles, are internally linked in such a way that they maintain a substantially fixed two-dimensional form. Even though they may be flexible in a third dimension they are not generally free to stretch or distort as is inherent in a true textile. Preferably the textile substrate is more than 100 meters in length and may be provided on a roll or the like having a width of greater than 1 meter. Cotton and treated cellulosic fibres are preferred.

The term ‘formulation’ herein encompasses aqueous solutions, aqueous dispersions, organic solutions, organic dispersions, curable liquid mixtures and molten compounds that comprise an active component According to an important advantage of the invention, the formulation may be non-reactive with the substrate. In this manner, the formulation may be applied to a greater diversity of substrates than would otherwise be the case.

The term ‘flame retardant’ is herein used to refer to the inhibition or prevention of the spread of a flame throughout a textile material. In addition it is intended to include the suppression of the formation of smoke within the textile when exposed to a heat source. Equally, flame retardant fabrics are treated as self-extinguishing without excessive flame, after-glow or smoking after removal of the ignition source. It is intended to cover materials meeting e.g. the ISO 15025:2000 (E) and NEN-EN 532 test standards.

The term ‘digital nozzle’ is intended to refer to a device for emitting a defined droplet from a supply of agent in response to a digital signal and depositing the droplet at a defined and controllable position. The term includes inkjet printing heads working on both the continuous flow and drop-on-demand principles. It also includes both piezoelectric and thermal inkjet heads and encompasses other equivalent devices capable of digital droplet deposition. Digital nozzles are generally well known to the skilled person in the field of graphic printing. It is considered that the nozzles of this invention can have an outlet diameter between 10 and 200 microns, preferably between 50 and 150 microns and most preferably around 100 microns.

The advantage of the selective dispensation of the finishing formulation is that it provides the possibility of on-demand delivery and importantly allows very uniform layers of the finishing formulation to be applied due to the very precise dosage and control of the nozzles which are possible; the digital nozzles can position drops very accurately onto the substrate with placement errors of only +/−10 microns. This accuracy of placement eliminates substantially the possibility of producing a substrate having regions that are uncovered, even when a minimum of the finishing formulation is applied. Nevertheless, the ability to form a patterned surface is highly advantageous in that, should it be desired, different parts of a textile can be imparted with different levels of flame retardation depending on the function to which the article is put.

The ejection of the formulation from the digital nozzles may additionally be controlled accurately to thereby control the penetration of the formulation into the textile. In accordance with a preferred embodiment the formulation is dispensed onto only one side of the substrate and, further, such that it penetrates the textile substrate to a maximum depth of ½ of the thickness of said substrate. This allows for the possibility of treating only one side of the textile substrate, allowing the other side thereof to better retain its original properties and/or functionality.

According to an important aspect of the present invention, a transport surface may be provided for moving the textile substrate past the array of nozzles, the substrate being retained by the transport surface for movement therewith. Because of the ability of textiles to stretch or distort, the use of such a transport surface may ensure that the substrate remains flat and that no relevant movement takes place during the process. As machine and staging errors can contribute to placement error, the flatness of the substrate allows for small standoff distances which can lessen the impact of trajectory errors. The transport surface may be in the form of a conveyor belt, to which the substrate is temporarily affixed e.g. by a release adhesive or by vacuum. Alternatively, the transport surface may be a shape-retaining carrier layer to which the textile is affixed, e.g. a backing film. Within such an arrangement, the textile substrate may be considered analogous to a flat, pixilated screen on which the droplets of the finishing formulation can be deposited in a square matrix or other controlled format

The nozzles of the device have a preferably static position, wherein the textile is guided along the nozzles. In this way substantially higher speeds can be achieved for the transport of the textile compared to spraying systems where the nozzles are required to traverse the moving substrate. More preferably the array of nozzles are provided as parallel rows thereof; this arrangement enables effective coverage of the textile substrate as it is positioned—or moves—below the array. It does not necessarily have to be the case that the dispensing of the formulation is carried out by each row or each nozzle of each row. Equally, each row and/or constituent nozzle can be used to dispense the formulation at a different time.

Dispensing materials from digital nozzles, in particular under conditions of continuous flow, is a high shear technique and materials that are not stable to shear may decompose within the nozzle or print head, blocking it Consequently this limits the formulations particularly in respect to the viscosity of the carrier. Shear thickening fluids should be avoided. In accordance with this invention it is preferable that the formulation has a viscosity less than 25 centipoise, but preferably greater than 3 centipoise (as measured with a Brookfield viscometer) at the temperature of operation, which is typically between 10° C. and 60° C.

Related to the property of viscosity, the surface tension of the droplet controls the wetting of the fluid inside the nozzle. If the surface tension is too high the formulation will not wet the internal surface of the nozzles properly leaving air pockets that prevent reliable release of the droplets. If the surface tension is too low the meniscus at the nozzle aperture will not form properly and the formulation will spontaneously flow therefrom. Accordingly it is preferable that the droplets dispensed from the said nozzle have a surface tension in the range between 20 and 50 dynes/cm and more preferably between 25 and 40 dynes/cm.

With respect to solutions and dispersions, the solids content thereof in part determines the pressure required both to eject a droplet from the digital nozzle and then break it up to achieve effective deposition; the solids act to dampen the pressure pulse used to eject the droplet Conversely, however, it is advantageous to have a high solids' content as this will limit the amount of drying or other post-treatment required to release the active component from the formulation. Accordingly, the formulation is preferably provided having a residual solids content of greater than 2%, more preferably greater than 5% and most preferably greater than 15%.

Related to the property of the solids content of the formulation is the particle size of these solids i.e. the dimensions of any crystalline structure, polymer micelle or nanoparticle. As inkjet nozzles are so small there is a maximum size of particle that can be borne within the formulation and that can fit through the pore of aperture of the nozzle. This maximum particle size is substantially smaller than the nozzle diameter due to crowding effects. Accordingly in this invention, it is preferable that any particles of formulation have a diameter less than 5 microns, more preferably less than 2 microns and most preferably less than 0.5 microns. It has been found most significant that the formulation is of a consistent quality in this respect Reference to particle size smaller than a given diameter is thus intended to refer to the D₉₉ diameter or better. The formulation should also not be subject to flocculation or sedimentation. This is intended to mean that the composition does not form particles greater than the given values during prolonged use or when the inkjet device is idle during its normal use. It is understood that many compositions may e.g. form sediment during prolonged storage but that this may be overcome by appropriate mixing arrangements.

Although it is envisaged that the method of this application may be performed by providing each droplet of formulation on demand, it is preferable that the printing head is of the continuous inkjet flow type and the functional formulation is deposited by continuous inkjet flow deposition. In the continuous flow method, pumps or other sources of pressure carry a constant flow of agent to one or more very small outlets of the nozzles. Under the influence of an excitation mechanism such a jet breaks up into a constant flow of droplets of the same size. One or more jets of agent are ejected through these outlets. The most used excitator is a piezo-crystal although other forms of excitation or cavitation may be used. From the constant flow of droplets generated only certain droplets are selected for application to the substrate of the textile. For this purpose the droplets are electrically charged or discharged. There are two variations for arranging droplets on the textile; binary CIJ and multi-deflection CIJ. According to the binary deflection method, drops are either charged or uncharged. The charged drops are deflected as they pass through an electric field in the print head. Depending on the configuration of the specific binary CIJ printer, the charged drops may be directed to the substrate whilst the uncharged drops are collect in the print head gutter and re-circulated, or vice versa. According to a more preferred method known as the multi-deflection method, the droplets are applied to the substrate by applying a variable level of charge to them before they pass through a fixed electric field, or conversely by applying a fixed level of charge to the drops before they pass through a variable electric field. The ability to vary the degree of the charge/field interaction on the drops means that the level of deflection they experience (and thus their position on the substrate) can be varied, hence ‘multi-deflection’. Uncharged drops are collected by the print head gutter and re-circulated. More specifically this method comprises:
feeding the formulation to the nozzles in almost continuous flows;
breaking up the continuous flows in the nozzles to form respective droplets, whilst simultaneously applying an electric field, as required, to charge the droplets;
applying a second electric field so as to deflect the drops such that they are deposited at suitable positions on the textile article.

Using this method the deflection and final position at which the different droplets come to lie on the substrate can be finely adjusted.

Use of the continuous inkjet method makes it possible to generate between 64,000 and 125,000 droplets per second per jet This large number of droplets and a number of mutually adjacent heads over the whole width of the cloth results in a relatively high productivity: in view of the high jetting speed, a production speed can be realized in principle of about 20 metres per minute using this technology. In view of the small volume of the reservoirs associated with the nozzles, a changeover to a different finishing regime may be realized within a very short time. However, it is a requirement of continuous inkjet that the formulation has a conductivity to allow the droplets to be charged and so that they can be deflected by the electric field. Accordingly it is preferable that the flame retardant formulation has a conductivity greater than 500 μS/cm.

Typically the flame retardant formulation is provided as a solution or dispersion in an aqueous carrier. In this embodiment, the pH of the formulation will influence the solubility or dispersion stability of the components in the fluid. Although the pH range may be limited by the tolerance of the digital nozzle to corrosion it is preferable herein that the formulation has a pH in the range between 4 and 10, and more preferably between 5 and 7.5.

On the basis of the determined properties of the flame retardant formulation chosen the droplets form a pixel of a given diameter, preferably between 120 and 500 microns, on impinging on and perhaps penetrating the substrate surface.

In accordance with a preferred embodiment the individual nozzles are-directed with a central control, provided for instance by a computer. The computer may preferably employ a drop and position visualization system that can be used to establish the optimum print head operating conditions and verify the quality of the droplet formation.

According to the present invention there is also provided a flame retardant formulation for application by digital droplet deposition to a textile substrate, the formulation comprising: i) 1 to 30 wt % of a flame retardant agent preferably selected from the group consisting of intumescent particles, halogen free organic salts, organophosphorous compounds, ammonium phosphate, ammonium diphosphate, and polyurethane resins; ii) 50 to 95 wt % of water; and optionally iii) at least one component selected from the group consisting of co-solvents, humectants, anti foaming agents, viscosity control agents, conductivity agents, surfactants, biocides, pH modifiers, corrosion inhibitors and wetting agents. In this context, the value of 1 to 30 wt % of the flame retardant agent is intended to refer to the quantity of active component even though this may be commercially supplied in a formulation already combined with water or other additional components.

In accordance with a still further embodiment of the invention there is provided a textile substrate provided with a substantially continuous flame retardant finish by the digital deposition thereon of a flame retardant formulation.

The flame retardant finish may be applied directly to the substrate. However, the textile article that is finished in accordance with this invention is preferably pretreated. The skilled reader would be aware that the pretreatment steps that can be applied to textiles before finishing are numerous and that the appropriate steps to be employed will depend on the types of fibers in the textile and the fabric construction. However, in the present invention, it is preferable that the pretreating of the textile article includes at least one processing step selected from the group consisting of bleaching, optically whitening, painting, printing and coating of the textile. Where pretreatment is required, it is further preferred that the chemical agents used therein are applied to the substrate by second or further arrays of nozzles disposed before the first array. Pretreatment of the textile may be divided into functional and process pretreatments. Functional pretreatments are those steps that are provided to impart additional functionality to the textile. Process pretreatments are those steps that may be additionally required or desired in order to effectively perform the process step of digital deposition of a flame retardant. According to an important aspect of the present invention, no additional process pretreatments may be required over and above the steps used in pretreating conventionally finished textiles.

Concomitantly, after the flame retardant finish has been applied, the finished substrate may be subjected to post-treatment. Preferably this post-treatment includes at least the step of drying the substrate. Further post-treatment steps will be apparent to a person of ordinary skill in the art and would, by way of example only, include curing by the use of UV radiation or heat treatment. It is perceived that the flame retardant finish may be overcoated with one or more further layers of coating using second or further arrays of nozzles to provide an enhanced durability finish, which is less susceptible to abrasion.

The finishing formulation for the application to the substrate preferably comprises a flame retardant agent selected from the group consisting of intumescent particles, halogen free organic salts, organophosphorous compounds, ammoniun phosphate and ammonium diphosphate. Most preferably the flame retardant comprises a halogen free organic salt. A preferred organic phosphorus-nitrogen compound that has demonstrated excellent jettability is Flamentin KRE™ available from THOR.

The aforementioned formulation is preferably carried in an aqueous solution. In order to achieve effective application by digital deposition the agent or carrier should preferably be formulated in accordance with the Tables below, wherein the reader is asked to note that that some of the compounds are optional therein. As the formulations closely determine the viscosity and conductivity of the droplet, the exact formulations employed will be variant dependent on the mode of droplet deposition employed. Droplet deposition by drop-on-demand for example subjects the formulations to a much lower shear than continuous inkjet methods.

Table 1 shows the preferable component ranges of the formulations for application in water-based solutions or dispersions in each of the defined droplet application technologies.

The aqueous solutions or dispersions of the active components are preferably in deionised water to limit the influence of inorganic ions in the compounds.

Co-solvent may often be required to improve the solubility of the active component(s) and its compatibility with the conductivity agent (as incompatibility between these materials is a common formulation issue). Typically the co-solvents are low boiling point liquids that can evaporate from the surface of the substrate after acting as the carrier of the active component It is preferable to use a co-solvent selected from the group consisting of ethanol, methanol and 2-propanol.

TABLE 1
Water Based Carrier
Formulations defined by % By weight

| | | Multideflection | Thermal Inkjet | |
|---|---|---|---|---|
| | Binary CIJ | CIJ | (TIJ) | Piezo DOD |
| Water | 70-95 | 50-90 | 70-95 | 60-90 |
| Co-solvent | 0 | 0-20 | 0-3 | 0-5 |
| Humectant | 0-3 | 0-5 | 10-30 | 10-35 |
| Viscosity control agent | 0-2 | 0-10 | | |
| Conductivity agent | 0-0.5 | 0-0.5 | | |
| Surfactant | 0-0.5 | 0-0.5 | | |
| Biocide | 0-0.5 | 0-0.5 | 0-0.5 | 0-0.5 |
| pH modifier | 0-1 | 0-1 | 0-1 | 0-1 |
| Corrosion inhibitor | 0-0.2 | 0-0.2 | 0-0.2 | 0-0.2 |
| Wetting Agent | 0 | | 0.01-0.3 | 0.01-0.3 |
| Flame Retardent component(s) | 5-20 | 5-30 | 1-5 | 5-30 |
| Anti foaming agent (Respumit S) | 0-2 | 0-2 | 0-2 | 0-2 |

Humectant is usually a low volatility, high boiling point liquid that is used to prevent crusting of the nozzle when the jet(s) are not active. Preferably the humectants are selected from the group consisting of polyhydric alcohols, glycols, especially polyethylene glycol (PEG), glycerol, n-methyl pyrrolidone (NMP). Although with certain formulations it may appear that more than 5% humectant is being used, it is in fact the case that the same material may also be present as a viscosity modifier.

Viscosity control agents or complex binders are the key ingredient for inkjet printing reliability and quality as it controls the droplet formation and break up process. Preferred viscosity control agents include polyvinylpyrrolidone (PVP), polyethylene oxide, polyethylene glycol (PEG), polypropylene glycol, acrylics, styrene acrylics, polyethyleneimine (PEI), polyacrylic acid (PAA). K-30 weight grade PVP has been found particularly useful due to its low bacterial sensitivity and its non-ionic nature.

Conductivity is required for CUI to allow the droplets to be charged and therefore deflected and conductivity agents are used when insufficient conductivity is naturally present in the ink. Conductivity agents must be selected that are compatible with the other components of the formulation and do not promote corrosion. Known conductivity agents suitable in this regard include lithium nitrate, potassium thiocyanate, dimethylamine hydrochloride. Thiophene-based materials, for example polythiophene or thiophene copolymers including 3,4ethylenedioxythiophene (EDT) and polyethylenethiophenes. Potassium thiocyanate has been found particularly useful for jetting purposes as relatively little is required to achieve the desired conductivity.

Surfactants are typically included either to reduce foaming of the formulation and release dissolved gases or to lower the surface tension of the droplet and thereby improve wetting. Preferable surfactants for the flame retardent finishing formulation of the present invention include Surfynol DF75™, Surfynol 104E™, Dynol 604™ (all available from Air Products) and Zonyl FSA™ (available from Du Pont). BYK 022™ (available from BYK-Chemie) and Respunit S™ (available from Bayer) are both silicone based antifoam agents that have proved very effective for jetting purposes.

Degassing agents can be oxygen scavengers such as cylcohexanone oxime which will remove dissolved oxygen or gas release agents such a Surfynol DF75™ (available from Air Products) which will act to encourage gases to be released from the fluid and not reabsorbed. They are preferably used in high surface tension fluids which are more likely to absorb gas and release it during jetting (particularly at high firing frequency).

pH modifiers are used to maintain a pH at which the solids of the formulation are soluble (or stably dispersed), typically this is pH>7, so most are alkaline. Preferred pH modifiers include Ammonia, Morpholine, Diethanolamine, Triethanolamine and Acetic acid.

Corrosion inhibitors are used to prevent unwanted ions present in the fluid (usually as impurities coming from the active components) from causing corrosion of the printer. The preferred corrosion inhibitor herein comprises tolytriazole or ethylenediaminetetraacetic acid (EDTA).

Wetting agents are utilized to improve the surface wetting of the fluid on the internal capillaries of the digital nozzle. Preferred wetting agents include acetylinic diols. Surfactants and co-solvents may also function as wetting agents.

In addition to the above-mentioned agents, the flame retardant formulation may optionally comprise a dispersant and/or a penetrant.

In accordance with a preferred embodiment of the invention the finishing formulation further includes a biocide. Many aqueous dispersions and emulsions can be seriously impaired during storage and use due to the growth of bacteria and fungi as: Staphylococcus Aureus, Salmonella typhosa, Klebsiella pneumoniae, Bacillus subtilis, Escherichia coli, Proteus vulgaris, Pseudomonas aeruginosa, Rhizopus stolonifer, Aspergillus penicilloides, Aspergillus niger, Altemaria radicina and Trichophyton mentagrophytes. The inclusion of a biocide may prevent or reduce degradation by these organisms. As used herein the term biocide refers to chemical substances intended to control insects or their larva, or to act as a bactericide, fungicide or virucide. By providing for the controlled and effective distribution of the biocide, this acts to delimit the influence of microbes before, during and after the finishing process for the textile.

Although it is envisaged that any biocide that is selective to such organisms may be suitable for inclusion in this invention, it is preferable that the biocides employed are selected from the group consisting of isothiazolinones, aldehydes, diacylhydrazine, triazines, quaternary ammonium compounds, bydroxymethyl ureide derivatives, etheramines, ethernitriles, hydantoins, alkylmetatoluamides, alkyl phthalates, chloronicotinyl compounds, n-methlycarbamates, organochlorine compounds, organophosporous compounds, pheromones, pyrazoles, pyrethroids, halogenated phenols, azoles, benzinidiazoles, carboxamides, dicarboxamides, dithicarbamates and substitutes benzenes. More preferably, the biocides are selected from the group consisting of N-N-diethylmetatoluamide (DEET), 3-Bromo-1-chloro-5,5-dimethyl-2,4imidazolinedione (BCDMH), 5-Chloro-2-methylisothiazol-3-one (CMI), 2-Methyl-2,3-dihydroisothiazol-3-one (MI), 1,2-Benzisothiazolin-3-one, 1,3-Dichloro-5,5-Dimethylhydantoin (DCDMH), 1,3-Dibromo-5,5-Dimethylhydantoin (DBDMH), 2,2-Dibromo-2-Nitroethanol (DBNE), tetradecyl dimethyl ammonium bromide, tetradecyl dimethly benzyl ammonium bromide. Selection and use of the biocide is subject to regulatory requirements. For this purpose, 1,2-Benzisothiazolin-3-one has been found particularly appropriate.

### BRIEF DESCRIPTION OF THE DRAWINGS

Further advantages, features and details of the present invention will be elucidated on the basis of the following description for a preferred embodiment thereof. Reference is made to the following figures in which:

FIG. 1 shows a schematic block diagram of the process of upgrading a substrate;

FIG. 2 shows a view in perspective of a textile finishing device according to a first preferred embodiment of the invention;

FIG. 3 is a schematic side view of the textile finishing device of FIG. 2;

FIG. 4 is a schematic front view of the textile finishing device of FIG. 2;

FIG. 5 is a schematic plan view of the textile finishing device of FIG. 2; and

FIG. 6 is a schematic side view of the textile finishing device of FIG. 2 showing the presence of IR beaters.

### DESCRIPTION OF ILLUSTRATIVE EMBODIMENTS

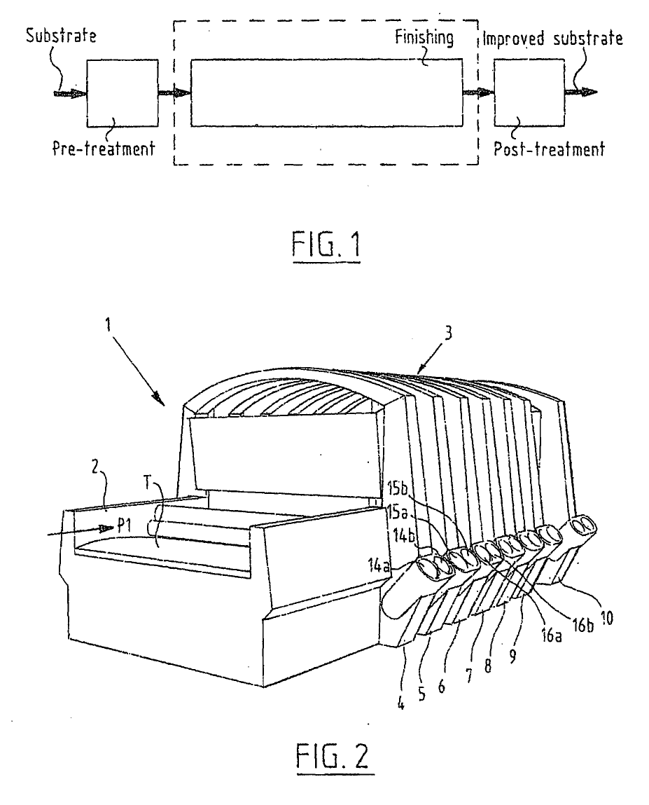

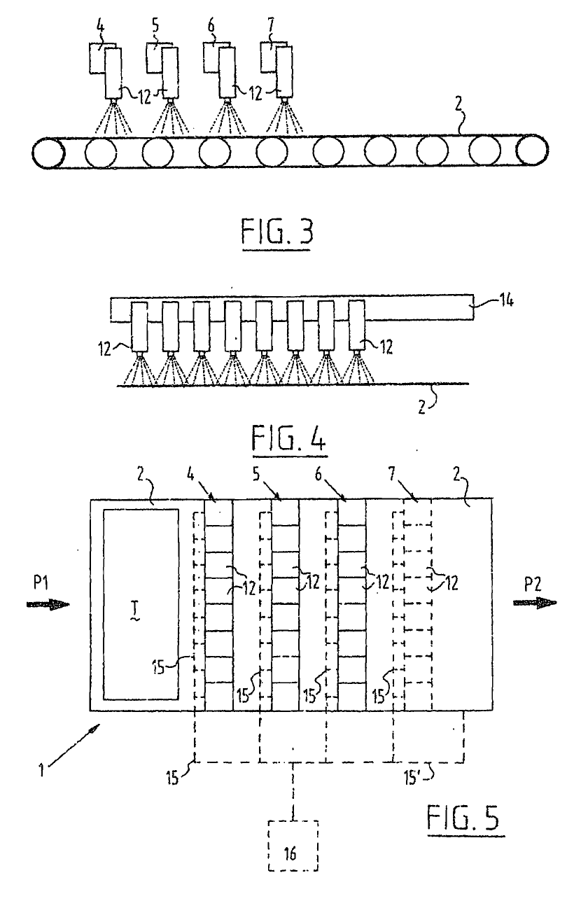

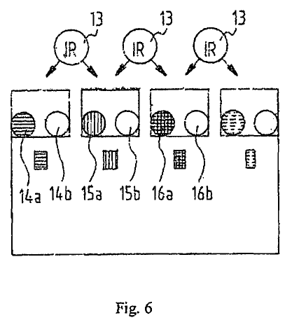

The following is a description of certain embodiments of the invention, given by way of example only and with reference to the drawings. Referring to FIGS. 2 to 6 show a textile finishing device 1 according to a preferred embodiment of the invention. Textile finishing device 1 is built up of an endless conveyor belt 2 driven using electric motors (not shown) On conveyor belt 2 can be arranged a textile article T which can be transported in the direction of arrow P1 along a housing 3 in which the textile may undergo a number of operations. Finally, the textile is discharged in the direction of arrow P2 (as shown in FIG. 4) for post-treatment. A large number of nozzles 12 are arranged in housing 3. The nozzles are arranged on successively placed parallel beams 4, 5, 6, 7. A first row 4, a second row 5, a third row 6 and so on are thus formed. The number of rows is variable (indicated in FIG. 5 with a dotted line) and depends among other factors on the desired number of operations. The number of nozzles per row is also variable and depends among other things on the desired resolution of any designs to be applied to the textile. In a particular preferred embodiment, the effective width of the beams is about 1 m, and the beams are provided with about 29 fixedly disposed spray heads, each having about eight nozzles of 50 μm diameter per head Each of the nozzles 12 can generate one or more jets of droplets of the finishing formulation.

In the preferred continuous inkjet method, pumps carry a constant flow of ink through one or more very small nozzles. One or more jets of ink, inkjets, are ejected through these holes. Under the influence of an excitation mechanism such an inkjet breaks up into a constant flow of droplets of the same size. The most used excitator is a piezo-crystal. From the constant flow of droplets generated only certain droplets are selected for application to the substrate of the textile. For this purpose the droplets are electrically charged or discharged. The uncharged droplets are undeflected and are collected by a collector or gutter. The charged droplets are directed onto the substrate using an electric field whereby either the charge or the field is varied such that the final position at which the different droplets come to lie on the substrate can be adjusted. Although in FIG. 2, the droplets are shown being deflected in the direction of movement of the substrate it is understood that this deflection could occur also in the transverse direction.

In FIG. 5 is indicated with dotted lines that the different nozzles 12 are connected (electrically or wirelessly) by means of a network 15 to a central control unit 16, which comprises for instance a microcontroller or a computer. The drive of the conveyor belt 2 is also connected to the control unit via network 15. The control unit can now actuate the drive and the individual nozzles as required.

Also arranged per row of nozzles 4-7 is a double reservoir in which the finishing formulation substance to be applied is stored. The first row of nozzles 4 is provided with reservoirs 14a,14b, the second row 5 is provided with reservoirs 15a,15b, the third row 6 is provided with reservoirs 16a,16b and so on. The appropriate formulation is arranged in at least one of the two reservoirs of a row. The nozzles 12 connected to each reservoir and disposed in different rows are directed such that the textile article undergoes the correct treatment with the finishing formulation. In this embodiment the textile article T is preferably treated with infrared radiation from light sources 13 in order to influence the coating of the finishing.

It is possible to treat different successively transported textile articles in different ways, in some cases even without transport of the textile therein having to be interrupted. It is for instance possible to have different finishing formulations applied to the textile through a correct choice of the reservoirs. The first reservoirs (14a,15a,16a) are for instance used in each case for a first type of textile, while the second reservoirs (14b,15b,16b) are used for a second type of textile.

### EXAMPLE 1

A formulation “Man 15 b” according to Table 2 was tested in a Linx 6000 CIJ printer using a 62 micron nozzle. It should be noted that although the flame retardant agent Flammentin KRE™ is present at 10 wt %, it is in a 40% aqueous solution. The overall concentration of functional agent is therefore 4 wt %.

TABLE 2

| | | Percentage By |
|---|---|---|
| Formulation Man 15b | Function | Weight (%) |
| Flammentin KRE (THOR) | Active flame | 10 |
| | retardant | |
| De-ionised water | Medium | 64.75 |
| Polyethylene Glycol 200 | Humectant | 15 |
| (Aldrich) | | |
| PVP K30 (25% in water) (ISP) | Viscosity Control | 10 |
| 10% Zonyl FSA (Dupont) | Surfactant | 0.15 |
| Proxel GXL1 (ISP)/Nuosept | Biocide | 0.1 |
| 4912 (ISP) | | |
| Respumit S (10% in DI water) | Anti foaming agent | 0.02 |
| Projet Fast Cyan 2 (Avecia) | Indicator | 0.25 |
| | (experimental) | |
| Total | | 100.25 |

The formulation was found to have the functional properties according to Table 3

TABLE 3

| Properties | |
|---|---|
| Filtration | 1.0 micron, filtered easily (1500 g) |
| Appearance | Transparent pale blue. Low foam. |
| Viscosity at 25° C., cP | 3.07 |
| Surface Tension, dynes/cm | 28.7 |
| Conductivity, mS/cm | 8.07 |
| pH | 6.28 |

The Man 15b formulation was jetted at different modulation voltages ranging from 5V to 200V. Drop formation and image quality were analysed and it was found that excellent result were achieved within a broad range of modulation voltages between 30V and 80V. Drop diameter was around 115 microns and drop volume 800 μL. The diameter of the printed dot was 270 microns.

The formulation was then reliability tested at a modulation voltage of 40V (pressure 217 ). After 90 minutes, jetting was terminated and the head and substrate were examined. No errors were detected in the printed textile. The print head was clean with no visible build-up of formulation.

### EXAMPLE 2

The formulation of Table 2 was then revised to significantly increase the concentration of the active flame retardant component according to Table 4. It should be noted that although the flame retardant agent Flammentin KRB™ is present at 70 wt %, it is in a 40% aqueous solution. The overall concentration of functional agent is therefore 28 wt %.

TABLE 4

| | | Percentage By |
|---|---|---|
| Formulation Man 41f | Function | Weight (%) |
| Deionised water | Medium | 18.83 |
| Respumit S (10% in DI water) | Antifoam | 0.02 |
| Polyethylene glycol 200 | Humectant | 10.00 |
| Nuosept 491 (10% in DI water) | Biocide | 1.00 |
| Zonyl FSA (10% in DI water) | Surfactant | 0.15 |
| Flammentin KRE (40% solids) | Flame Retardant | 70.00 |

The formulation was found to have the functional properties according to Table 5

TABLE 5

| Man 41f Properties | |
|---|---|
| Viscosity (cP at 25° C.) | 3.57 |
| pH | 5.27 |
| Surface tension (dynes/cm) | 35.5 |
| Filtration (um) | 6.0 |
| Solids (%) | 28.0 |
| Conductivity (mS/cm) | 25.5 |

The above formulation was deposited onto 280 gsm Cotton BD using a Domino JetArray™ inkjet printer. Printing a drop volume of 1300 pL at a cross web resolution of 54 dpi and a down web resolution of 369 dpi achieved the desired active functional coat weight (for this fabric weight) of 11.2 gsm. The increased functional material concentration allows the desired level of flame retardency to be deposited from a smaller number of droplets, which increases the line speed of the system and significantly reduces the amount of water used and therefore the drying power requirement.

The flame retardant formulation was also printed using a Linx 6000 CIJ printer with a 62 um nozzle at print resolution 138 dpi (down web) by 129 dpi (cross web) onto 150 g/m2 cotton, using multiple print passes to build up the required active flame retardant coverage. Average dot diameter was 270 microns.

The maximum amount of the functional component that may be used is limited by the solubility/compatibility of all of the materials in the formulation in the presence of a reduced water concentration, as well as the requirement for the desired level of functionality to be evenly spread throughout the fabric rather than existing as individual dots.

Flame retardant functionality is a ‘bulk effect’ functionality rather than a ‘surface effect’ functionality i.e. as the weight of the fabric is increased (or decreased), the desired coverage of active functional material is increased (or decreased) respectively. Therefore, the formulation Man 41f of Table 4 would not be ideal for low fabric weights, as printing at reduced resolution to achieve the desired functionality coverage (g/m2) would lead to individual dots rather than an even coating, conversely printing the above formulation at high enough resolution to produce continuous coverage of the substrate would apply more active functional material than required and would be wasteful.

To determine the optimum concentration of active flame retardant the following equation may be used:

CFR=CVRGreq/(1/√2.Dd)2.Dv

Where:
CFR is the optimum concentration of active flame retardant in g/L;
CVRGreq is the required coverage of active flame retardant in gsm;
Dd is the printed dot diameter in m; and
Dv is the drop volume in L.

The invention is not limited to the above described embodiments thereof. The rights sought are rather defined in the following claims, within the scope of which many modifications can be envisaged.

1. A method of producing a textile article having a flame retardant finish comprising:
providing a continuous supply of a textile substrate having a width;
providing an array of digital nozzles over the width;
supplying a flame retardant formulation to the nozzles; and
selectively dispensing the flame retardant formulation from the nozzles in a predetermined pattern of droplets to produce a substantially complete covering of the article with no significant flammable residue.

2. The method according to claim 1, wherein the array of digital nozzles is static and wherein the textile substrate is provided by guiding it past said array.

3. The method according to claim 1, wherein said textile substrate is provided on an endless conveyor belt.

4. The method according to claim 1, wherein said array of nozzles comprises a plurality of parallel rows.

5. The method according to claim 1, wherein said formulation is supplied as a solution or dispersion in water.

6. The method according to claim 5, wherein said dispensing of the formulation is effected by a device of the continuous inkjet type, the method comprising:
feeding the formulation to the nozzles in almost continuous flows;
breaking up the continuous flows in the nozzles to form respective droplets, whilst simultaneously applying an electric field, as required, to charge the droplets;
applying a second electric field so as to deflect the drops such that they are deposited at suitable positions on the textile article.

7. The method according to claim 1, wherein the formulation is dispensed only onto one side of the textile substrate.

8. The method according to claim 7, wherein the formulation is dispensed such that it penetrates the textile substrate to a maximum depth of ½ of the thickness of said substrate.

9. The method according to claim 1, wherein the droplets are deposited at a temperature in the range between 10° and 60° C.

10. The method according to claim 1, wherein a concentration of flame retardant material in the flame retardant formulation is given by:
CFR=CVRGreq/(1/√2.Dd)2.Dv
where:
CFR is the optimum concentration of active flame retardant in g/L;
CVRGreq is the required coverage of active flame retardant in gsm;
Dd is a printed dot diameter in m; and
Dv is a drop volume in L.

11. A flame retardant formulation for application by digital droplet deposition to a textile substrate, the formulation comprising:
i) 1 to 30 wt % of a flame retardant agent preferably selected from the group consisting of intumescent particles, halogen free organic salts, organophosphorous compounds, ammonium phosphate and ammonium diphosphate;
ii) 50 to 95 wt % of water; and optionally
iii) at least one component selected from the group consisting of co-solvents, humectants, viscosity control agents, conductivity agents, surfactants, biocides, pH modifiers, corrosion inhibitors and wetting agents, wherein the dispensed droplets have a surface tension in the range between 20 and 50 dynes/cm preferably between 25 and 40 dynes/cm and dry to leave a non-flammable residue.

12. The formulation according to claim 10, having a pH in the range between 4 and 10 and more prefer ably between 5 and 7.5.

13. The formulation according to claim 10, having a viscosity less than 25 centipoise, more preferably less than 15 centipoise but most preferably greater than 3 centipoise as measured with a Brookfield viscometer.

14. The formulation according to claim 10, having a residual solids content of greater than 2%.

15. The formulation according to claim 10, wherein the formulation has a conductivity greater than 500 μS/cm.

16. The formulation according to claim 10, wherein any particles therein have a diameter of less than 5 μm.

17. A textile substrate provided with a substantially continuous flame retardant finish by the digital deposition thereon of a flame retardant formulation.

18. A textile substrate according to claim 17, wherein said substantially continuous finish imparts different levels of flame retardancy to different parts of the substrate.

19. The formulation according to claim 10, having a residual solids content of greater than 15%.

20. The formulation according to claim 10, wherein any particles therein have a diameter of less than 0.5 μm.
